(19) United States
(12) Patent Application Publication
(10) Pub. No.: US 2018/0357720 A1
(43) Pub. Date: Dec. 13, 2018

(54) Detection of Real Estate Development Construction Activity

(71) Applicant: STATE FARM MUTUAL AUTOMOBILE INSURANCE COMPANY, Bloomington, IL (US)

(72) Inventor: Rosemarie Geier Grant, Ellsworth, IL (US)

(21) Appl. No.: 14/840,334

(22) Filed: Aug. 31, 2015

(51) Int. Cl. G06Q 40/08

(52) U.S. Cl. CPC G06Q 40/08; G06Q 50/165

(57) ABSTRACT

In a computer-implemented method of detecting real estate development construction activity for insurance purposes, first image data corresponding to a first set of one or more images of a geographic area is received. The first image data may be processed to determine at least one characteristic of the geographic area. Based upon the at least one characteristic of the geographic area, it may be determined that real estate development construction activity is occurring at a site at least partially within the geographic area. In response to determining that real estate development construction activity is occurring at the site, an alert indicative of a new real estate development may be provided.

### FIELD OF THE DISCLOSURE

The present disclosure generally relates to image processing and detection, and, more specifically, to systems and methods for detecting real estate development construction activity, such as construction activity for new housing, commercial or industrial developments.

### BACKGROUND

Accurate and timely information regarding new real estate developments (e.g., housing, commercial or industrial developments) may be useful for a number of different purposes. For example, insurance providers may desire such information in order to effectively direct marketing efforts, and/or to gain knowledge for risk underwriting purposes. As another example, providers of mapping products or services may desire such information in order to provide more accurate, up-to-date maps.

In the insurance realm, early identification of new real estate developments can be particularly valuable because risk underwriters are increasingly relying on new technologies to facilitate the assessment of new business (e.g., properties that may be insured). For example, underwriters for home insurance policies increasingly use online map services, such as Google Maps or Bing Maps, that provide satellite and/or street-level imagery. These map services allow underwriters to obtain important information that may be predictive of the risk of loss, and/or the amount of potential loss (e.g., costs of repairs/replacements), and may therefore be relevant to insurability and/or premium levels. Unfortunately, existing online map services are geared toward existing and completed homes, and tend to lag behind with respect to new housing developments (e.g., new housing subdivisions). As new housing developments are built, for example, the initial wave of new homes are typically erected on streets that have not yet been mapped, and the map services may not even provide any photographic evidence of the new homes. Moreover, there is currently no publicly available, nationwide database that tracks when a developer applies for new subdivision approval, or when a local jurisdiction grants a permit to a developer. Thus, new homes in these locations tend to lack an “online presence” until traditional mapping companies revisit the relevant location, at a time that may be well after the homes have been built and/or inhabited.

The lack of timely data concerning new homes (or other properties) will likely prove to be problematic and frustrating, particularly as insurance providers and underwriters continue to become more reliant on remote imagery. Further, key marketing opportunities may be missed if insurance providers must wait for new housing or other developments to have an online presence before becoming aware of the properties in those developments.

### BRIEF SUMMARY

The present embodiments may, inter alia, provide more timely and/or accurate information about new real estate (e.g., housing, commercial, industrial, etc.) developments. The information may be useful to facilitate underwriting and/or insurance marketing efforts, to generate/maintain accurate and up-to-date digital maps, or for other purposes.

In one aspect, a computer-implemented method of detecting real estate development construction activity for insurance purposes may include (i) receiving, by one or more processors, first image data corresponding to a first set of one or more images of a geographic area, (ii) processing, by one or more processors, the first image data to determine at least one characteristic of the geographic area, (iii) determining, by one or more processors and based upon the at least one characteristic of the geographic area, that real estate development construction activity is occurring at a site at least partially within the geographic area, and (iv) in response to determining that real estate development construction activity is occurring at the site, providing, by one or more processors, an alert indicative of a new real estate development to an insurance provider.

In another aspect, a system for detecting real estate development construction activity for insurance purposes may include a communication interface, one or more processors, and a program memory storing instructions. The instructions, when executed by the one or more processors, may cause the one or more processors to (i) process first image data, received via the communication interface and corresponding to a first set of one or more images of a geographic area, to determine at least one characteristic of the geographic area, (ii) determine, based upon the at least one characteristic of the geographic area, that real estate development construction activity is occurring at a site at least partially within the geographic area, and (iii) in response to determining that real estate development construction activity is occurring at the site, provide an alert indicative of a new real estate development to an insurance provider.

In another aspect, a computer-implemented method of detecting real estate development construction activity for insurance purposes may include (i) receiving, by one or more processors, first image data corresponding to one or more satellite images of a geographic area, (ii) processing, by one or more processors, the first image data to determine at least one characteristic of the geographic area, (iii) determining, by one or more processors and based upon the at least one characteristic of the geographic area, that real estate development construction activity is occurring at a site at least partially within the geographic area, (iv) in response to determining that real estate development construction activity is occurring at the site, causing, by one or more processors, one or more unmanned aerial vehicle (UAV) images of at least a portion of the geographic area to be captured, (v) receiving, by one or more processors, second image data corresponding to the one or more UAV images of at least the portion of the geographic area, and (vi) providing, by one or more processors, the second image data to a computing device or system to facilitate risk underwriting with respect to one or more insurance policies.

### BRIEF DESCRIPTION OF THE DRAWINGS

The figures described below depict various aspects of the systems and methods disclosed herein. It should be understood that each figure depicts an embodiment of a particular aspect of the disclosed systems and methods, and that each of the figures is intended to accord with a possible embodiment thereof.

FIG. 1 depicts a block diagram of an example system for detecting, and gathering additional information relating to, new real estate developments, according to an embodiment.

FIGS. 2A through 2C depict example satellite images, taken over a period of time, of a geographic area that includes the site of a new housing development, according to one embodiment and scenario.

FIG. 3 depicts a flow diagram of an example method of detecting real estate development construction activity, according to an embodiment.

FIG. 4 depicts a flow diagram of an example method of detecting real estate development construction activity for insurance purposes, according to an embodiment.

### DETAILED DESCRIPTION

### I. Example Detection of Real Estate Development Construction Activity

The present embodiments generally relate to using remote, non-terrestrial (e.g., satellite) imagery to detect real estate development construction activity. Real estate developments may include housing developments (e.g., subdivisions), commercial developments (e.g., malls, business parks, etc.) and/or industrial developments, for example. The construction activity map be detected for various purposes, such as insurance marketing and/or underwriting, or collecting information for digital maps, for example.

In an embodiment, an initial phase includes utilizing relatively low-cost, low-resolution “flock” satellites to capture terrestrial images of locations within a wide geographic area on a relatively frequent basis (e.g., each location several times per day). While the resolution of these flock-type satellites may not be as high as traditional, larger satellites, their relatively low cost and ability to image the same location more frequently may make them suitable for use with the systems and methods disclosed herein. In some embodiments, however, larger satellites that provide higher resolution images are instead utilized.

Once captured, the satellite images may be transmitted or otherwise transferred to a server for storage. The server may then utilize suitable image processing techniques to determine a set of characteristics for each of some or all of the images, with the characteristics being indicative of real estate development construction activity (or the lack thereof). For example, the image processing techniques may be used to identify grading characteristics (e.g., flat or uneven terrain), road characteristics (e.g., road patterns, densities, lengths, cul-de-sacs, etc.), earth-moving construction equipment, objects having shapes and sizes typical of concrete foundations, and so on.

An algorithm may be used to determine whether the identified characteristics indicate a new real-estate development. As just one example, the server may determine that a new real estate development is under construction if flat grading (e.g., less than a threshold slope and/or degree of unevenness) and a dense pattern of roads (e.g., less than a threshold average length between intersections, etc.) are detected in a geographic area where no houses or other buildings were previously known to exist, and/or where the flat grading and/or dense road pattern did not exist according to processing of earlier satellite images of the same area.

In some embodiments, real estate development construction activity is identified if a particular series of stages is identified over time. For example, a server processing satellite images that depict the same geographic area, and were captured at several different points in time (e.g., different days, weeks, months, etc.), may determine that a new housing development is being built if uneven terrain is identified in a first image, flat grading is identified in a later, second image, roads (or additional roads) are identified in a still later, third image, and home foundation shapes/footprints are identified in an even later, fourth image. In other embodiments and/or scenarios, housing development construction activity may be detected based upon characteristics detected using only a single satellite image of a geographic area.

When the server detects a new housing or other real estate development, the server may alert one or more computing systems and/or individuals. For example, the server may alert employees of an insurance provider of the development and its location. The alert may be provided at an early stage, such as when a grading or road-building phase is underway, or may be provided at a later stage, such as when building foundations are detected.

The insurance provider may utilize the alert in various different ways, in different embodiments and scenarios, either directly or via a third party contractor. For example, the alert may prompt an insurance provider or other entity to contact a governing entity of the local jurisdiction of the new development in order to obtain street names and development details. As another example, the alert may cause a fleet of unmanned aerial vehicles (UAVs, or drones) to fly over the area on a regular basis (e.g., monthly) to capture more detailed images of homes, businesses, facilities, etc., in the new development. The more detailed images may be stored for later use by an underwriting department, for instance, to determine dimensions, locations, construction information and/or other information relating to the buildings/properties of the development. As yet another example, the alert may be provided to a sales division of the insurance provider in order to signal that new business relating to the new development (e.g., new customers) may be acquired.

By using some or all of the above techniques to provide near real-time data on new real estate construction activity, several advantages may be obtained. For example, an insurance provider may perform underwriting more quickly and efficiently (e.g., if an alert caused drones to gather more detailed home or building information in advance of that information being needed for underwriting), and may avoid or lessen inefficiencies associated with marketing and sales efforts. Moreover, many physical operations may be avoided when using these techniques. For example, insurance provider employees may need to do less “leg work” (e.g., driving through undeveloped areas, making telephone calls, browsing the Internet, etc.) in locating new real estate developments, and underwriters may need to initiate or perform less data collection at a later stage to obtain the information they need to perform their underwriting tasks.

### II. Example System for Detecting Real Estate Development Construction Activity

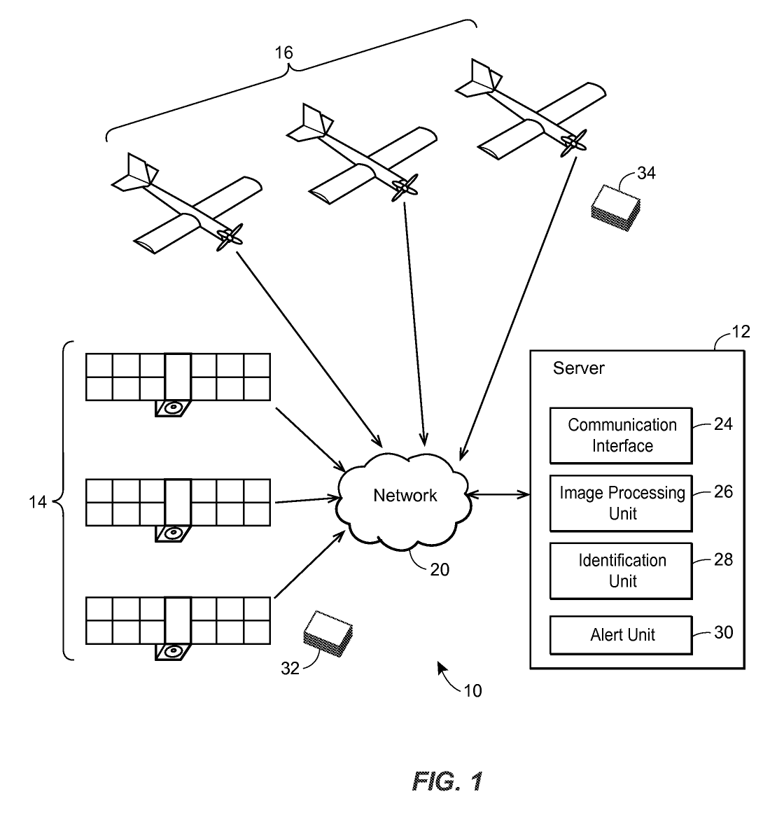

FIG. 1 depicts an example system 10 for detecting, and gathering information relating to, new real estate development construction, according to an embodiment. The system 10 may include a server 12, satellites 14, unmanned aerial vehicles (UAVs) 16, and a network 20. While FIG. 1 shows three satellites 14 and three UAVs 16 for purposes of simplicity, more or fewer of each may be included in the system 10.

The satellites 14 may collectively form a “flock” of numerous (e.g., 25 to 200), relatively small satellites, each with one or more image-capturing sensors. The satellites 14 may be deployed so as to orbit the earth at fairly frequent intervals, and collectively may provide the ability to image each of many geographic locations on a frequent basis (e.g., several times per day). The satellites 14 may each have a resolution of 50 to 100 cm, for example, or another suitable resolution. In other embodiments, the satellites 14 may instead, or also, include traditional, larger satellites with higher resolution that image each geographic location on a less frequent basis.

The UAVs 16 may include only a single UAV, or may include a “fleet” of UAVs, with each UAV including one or more image-capturing sensors. In some embodiments, each of some or all of the UAVs 16 may include one or more non-camera sensors that are configured to remotely sense terrestrial features. For example, each of some or all of the UAVs 16 may include one or more LiDAR devices, one or more radar devices, etc.

The network 20 may include any appropriate combination of local area networks (LANs), metropolitan area networks (MANs), wide area networks (WANs), and/or any other wired and/or wireless communication networks. As one specific example, the network 20 may include at least a satellite network for communications between satellites 14 and the server 12, a cellular network for communications between the UAVs 16 and the server 12, and a server-side LAN. As another example, the network 20 may include the Internet.

The server 12 may include a communication interface 24, an image processing unit 26, an identification unit 28, and an alert unit 30. In other embodiments, the server 12 may include additional, fewer, and/or different components and/or units than those shown in FIG. 1. Communication interface 24 may generally be configured to communicate with (i.e., transmit data to, and receive data from) remote systems or devices via network 20. Communication interface 24 may include multiple different communication interfaces, such as multiple hardware ports and associated software and/or firmware, for example.

As will be discussed in greater detail below, image processing unit 26 may generally be configured to process images of land (including images received via communication interface 24) to determine characteristics indicative of real estate development construction activity (or the lack thereof), identification unit 28 may generally be configured to identify/locate real estate development construction activity based upon the determined characteristics, and alert unit 30 may generally be configured to send information indicative of the output of identification unit 28 to one or more individuals and/or entities.

In an embodiment, each of units 24, 26, 28 and 30 is (or includes) a respective set of one or more physical processors that executes software instructions to perform the functions described below, or some or all of the units 24, 26, 28 and 30 may share a set of one or more processors. Alternatively, each of some or all of the units 24, 26, 28 and 30 may be a component of software that is stored on a computer-readable medium (e.g., a non-volatile memory of the server 12) and executed by one or more processors of the server 12 to perform the functions described herein. In some embodiments, one or more of the units 24, 26, 28 and 30 is also associated with hardware. For example, communication interface 24 may include one or more physical ports, network interface cards, etc.

In operation, one or more of the satellites 14 may collectively capture images 32 of terrestrial, geographic areas. The satellites 14 may include communication interfaces (not shown in FIG. 1) that wirelessly transmit the images 32 of the geographic areas to the server 12. The images 32 may be sent via network 20, and received by or via the communication interface 24 of the server 12, for example. In other embodiments, the images 32 are transferred to the server 12 in a different manner, such as wirelessly transmitting the images 32 to a third party server (not shown in FIG. 1) before sending the images 32 to the communication interface 24 of the server 12 via the network 20.

The server 12 may store the received images 32 for processing (e.g., in a persistent memory of server 12, or in another memory, not shown in FIG. 1). Image processing unit 26 may then process the images 32 using one or more image processing techniques to identify characteristics of the geographic areas depicted in the images 32. In particular, image processing unit 26 may attempt to identify a set of one or more characteristics/features that are indicative of real estate development construction activity (or the lack thereof), such as the grading of land (e.g., flatness, slope, etc.), roads and/or characteristics of those roads (e.g., distances between substantially parallel roads, distances between road intersections, the presence of cul-de-sacs, etc.), the presence of home or building foundations, and/or the presence of earth-moving construction equipment, for example. In some embodiments, however, the resolution of the satellites 14 does not readily permit accurate determining certain characteristics, such as the presence of construction equipment.

In some embodiments and/or scenarios, each of the images 32 depicts a different geographic area. In other embodiments and/or scenarios, the same geographic area may be depicted in two or more of the images 32. It is understood that, when reference is made herein to two or more different images depicting a single or same geographic area, that the images do not necessarily depict areas with precisely the same terrestrial boundaries. For example, the areas shown in the images may be bounded by different geographical coordinates, with only a partial overlap in the expanse of land shown in each image, or with the land depicted in one image being just a subset of the land depicted in the other image.

Image processing unit 26 may utilize any image detection, feature detection or extraction, pattern detection, edge detection, corner detection, blob detection, ridge detection, color detection, and/or any other suitable image processing technique(s) to determine the characteristic set for a particular geographic area shown in one or more of the images 32. For example, image processing unit 26 may implement a SIFT (Scale-Invariant Feature Transform) technique, a SURF (Speeded Up Robust Features) technique, and/or a Hough transform technique to determine the characteristic set. As a more specific example, image processing unit 26 may use an edge detection technique to determine a shape defined by the boundaries of a shape, and then measure the length and width of the shape (e.g., relative to some known reference length, or relative to each other, etc.) to determine whether the shape has dimensions appropriate to a home foundation. As another specific example, image processing unit 26 may calculate a metric indicative of variation in shading, texture, and/or color within a particular area, and use that metric to determine whether the area includes substantially flat ground or uneven ground.

After image processing unit 26 has determined a set of one or more characteristics of a particular geographic area, identification unit 28 may use the characteristic set to determine whether a new real estate development is under construction at a site that is at least partially within that geographic area. The rules or algorithms for determining whether a particular geographic area is associated with real estate development construction activity may vary according to different embodiments. In one embodiment, for instance, identification unit 28 may determine that a new housing development is in progress if and only if (1) at least a threshold area of land has flat grading, (2) roads within the area have at least a threshold density (e.g., average distance between intersections, and/or some other metric of density), and (3) five or more home foundations are detected. In another example embodiment, identification unit 28 may determine that a new housing development is in progress if either (1) all of the preceding criteria are met, or (2) roads within the area have at least a threshold density and earth-moving equipment is detected.

In some embodiments, identification unit 28 may determine not only whether real estate development construction is underway, but also a type or category of the development. For example, identification unit 28 may determine that a new housing development is in progress if one of the above set of criteria is satisfied, and instead determine that a commercial development is in progress if (1) at least a threshold area of land has flat grading, (2) pavement (e.g., parking lots and roads) occupies at least a threshold percentage of the area having flat grading, and (3) at least a threshold percentage of foundations within the flat grading area have at least a threshold size (e.g., a size too large for the typical home). In other embodiments, identification unit 28 only generates a binary indicator of whether a real estate development (of unspecified type) is in progress.

In some embodiments and scenarios, two or more of the images 32 correspond to the same geographic area and are taken at two or more different times (e.g., different days, weeks, months, etc.). Identification unit 28 may then decide whether a new real estate development is in progress at that area based upon how the characteristics of the geographic area change over time. For example, identification unit 28 may determine that a new real estate development is in progress if a particular succession of features/characteristics is detected within the geographic area. As a more specific example, real estate development construction activity may be detected if uneven ground is detected in a particular area (of at least a threshold size) shown in a first image, but a second, later image shows flat grading in that same area. As another specific example, real estate development construction activity may be detected if flat grading is detected in a first one of images 32, a particular pattern or threshold density of roads is detected in a later, second one of images 32, and home or building foundations are detected in a still later, third one of images 32.

In some embodiments, identification unit 28 may additionally use information obtained from a source other than satellite imagery to decide whether a new real estate development is in progress. For example, identification unit 28 may determine that a new housing development is in progress if and only if (1) identification unit 28 detects one or more characteristics indicative of housing development construction within the depicted geographic area, and (2) identification unit 28 accesses a database (stored in a persistent memory not shown in FIG. 1) to determine that there is currently no record of housing in that geographic area. Identification unit 28 may also decide whether a new housing (or other real estate) development is in progress based upon other factors, such as the proximity of the geographic area (or a site within the geographic area) to a large population center, for example.

When the identification unit 28 determines that real estate development construction activity is occurring, or likely occurring, in a particular geographic area, alert unit 30 may take one or more actions. For instance, alert unit 30 may prompt an insurance provider or other company to contact a governing entity of the local jurisdiction of the new development in order to obtain street names and other development details.

Alert unit 30 may accomplish this in various different ways. In one embodiment, for example, alert unit 30 may generate and send an automated email or other electronic message to one or more individuals (e.g., one or more employees and/or third party contractors associated with an insurance provider). The automated electronic message may include an indication of the location of the detected new real estate development (e.g., a latitude and longitude, a graphical icon on a map image, etc.). Alternatively, alert unit 30 may transmit an electronic signal to another server (not shown in FIG. 1), where the other server is directly responsible for distributing the information to the appropriate personnel.

Alternatively, or additionally, alert unit 30 may send an automated electronic message (e.g., an email) containing the new real estate development location information to one or more individuals (e.g., within a sales division of an insurance provider) in order to signal that new business relating to future homes or other properties in the area may be acquired. Again, alert unit 30 may instead transmit an electronic signal to another server (not shown in FIG. 1), where the other server is directly responsible for distributing the information to the appropriate personnel.

In addition to, or instead of, the above actions, alert unit 30 may cause the UAVs 16 to fly over the area in which new real estate development construction activity was detected, in order to capture more detailed (e.g., closer, and possibly higher resolution) images 34. At least for purpose of images 34, “images” may refer to photographic images, and/or to any other remotely sensed information (e.g., LiDAR images, radar images, spectrometer/spectral images, etc.).

In one such embodiment, alert unit 30 may send an automated email or other electronic message to one or more individuals (e.g., employees of an insurance provider or third party), suggesting that the area be further photographed (or otherwise surveyed/sensed) in greater detail. The recipients may then request or otherwise initiate one or more surveys (e.g., periodic surveys) using UAVs 16. In another embodiment, some or all of the UAVs 16 may be deployed on a regular basis, and an automated, electronic alert from alert unit 30 may cause the deployed UAVs 16 that are deployed nearer to the geographic area of interest to be directed or redirected to the appropriate coordinates.

Once captured by UAVs 34, the more detailed images 34 may be used for various purposes. For example, an underwriting department of an insurance provider may use the images 34 to determine dimensions, locations, construction information and/or other information relating to the homes or other properties of the development. Image processing unit 26, or a different image processing unit not shown in FIG. 1, may process the images 34 to determine such characteristics, and the characteristics may be stored in a database until needed. Alternatively, or additionally, the images 34 may themselves be stored in a database, and manually analyzed by employees of the insurance provider, or a third party, when more information about particular homes or other properties in the new development is needed.

While several specific examples have been provided above, it is understood that alert unit 30 may instead provide different sorts of information indicative of the new real estate developments (e.g., the particular type or category of the development, if one is identified by identification unit 28), may provide the information in a different manner, and/or may provide the information to a different recipient or system.

Further, it is understood that, in different embodiments, the division of functionality between image processing unit 26 and identification unit 28 may vary. In a first embodiment, for example, image processing unit 26 may both (1) determine distances between all road intersections within a geographic area and (2) calculate the average (and/or other metric(s)) of those distances. In a second embodiment, however, image processing unit 26 may only determine the distances, while identification unit 28 calculates the average (and/or other metric(s)) of the distances as a part of the algorithm for identifying real estate development construction activity.

As another example, in a first embodiment, image processing unit 26 may determine/output “characteristics” that are themselves changes to other characteristics or features. For example, one characteristic determined by image processing unit 26 may be “increased road density.” In a second embodiment, however, image processing unit 26 may only determine characteristics that are static (e.g., road density in each image), and identification unit 28 may determine characteristics reflecting changes to the static characteristics over time (e.g., increased road density) as a part of the identification algorithm.

As can be seen from the above discussion, the components in the system 10, when operating according to the techniques described above, may greatly hasten various processes (e.g., gathering information for underwriting/risk assessment and/or for sales/marketing purposes, or for updating a digital map, etc.), and may reduce the need to expend other human and electronic resources trying to discover new real estate developments.

### III. Example Satellite Images of Housing Development Construction Activity

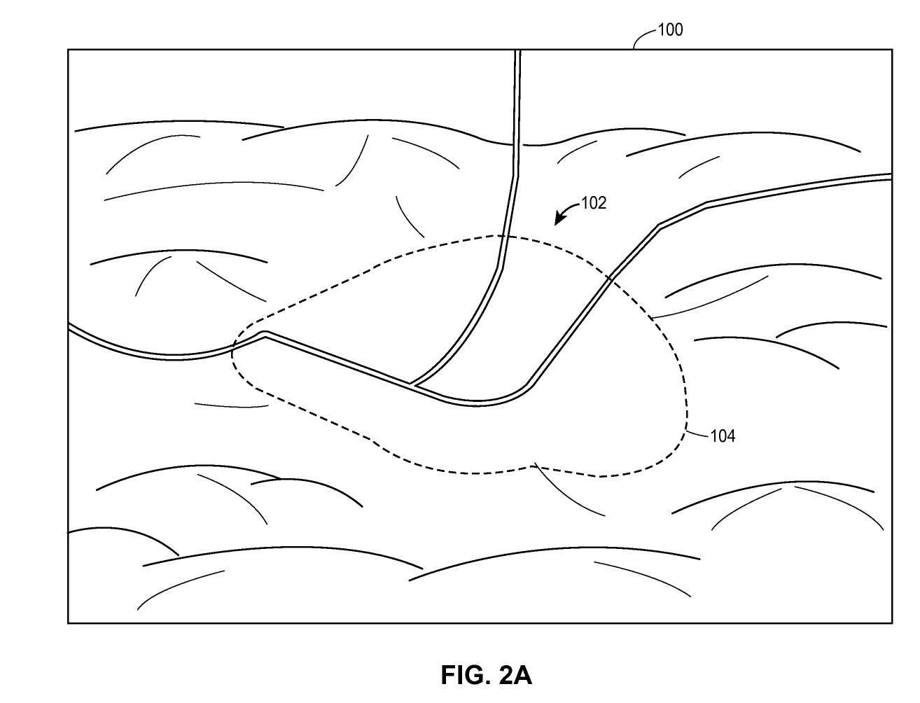

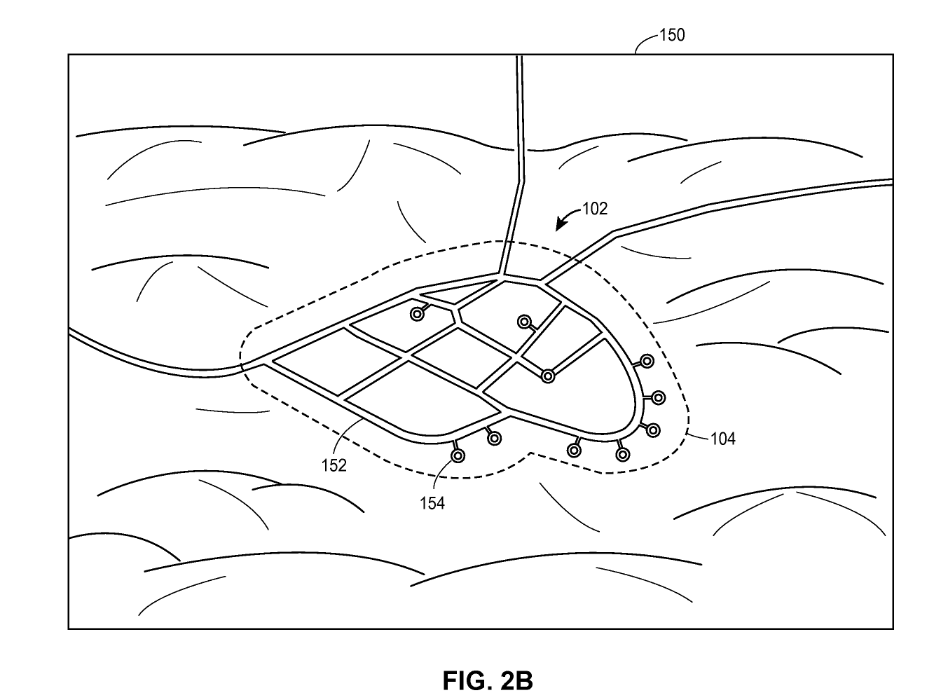

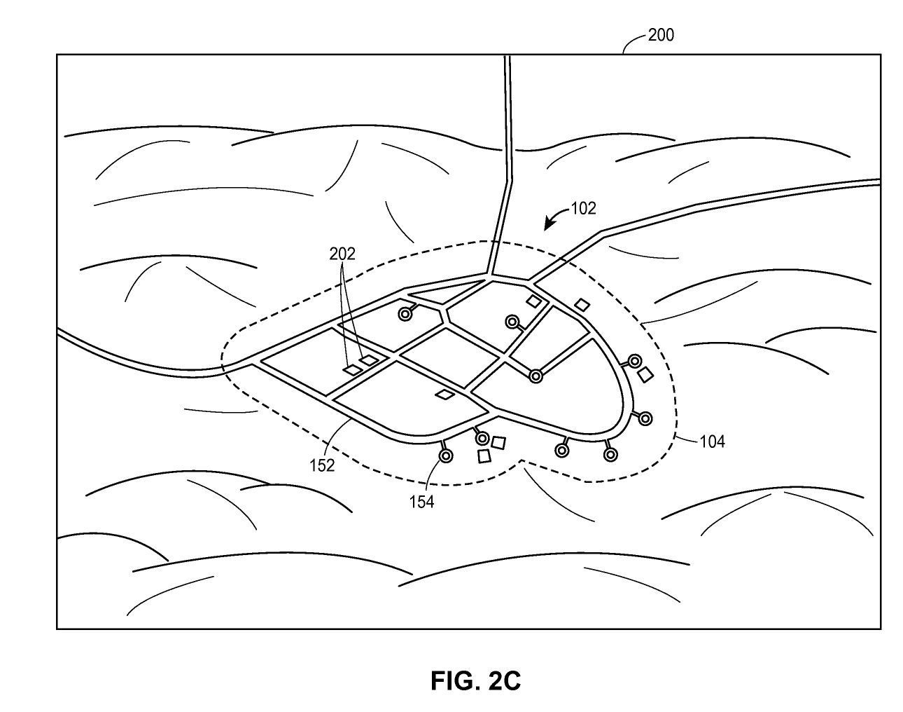

FIGS. 2A-2C depict example images of a geographic area in which housing development construction activity is underway, according to one embodiment and scenario. The images of FIGS. 2A-2C may be included within images 32 of FIG. 1, for example. FIGS. 2A-2C are discussed below with reference to various components of FIG. 1. While FIGS. 2A-2C portray stages of construction for a new housing development, it is understood that the present invention may, at least in some embodiments, also or instead detect construction activity for other types of real estate developments, such as commercial or industrial developments.

Referring first to FIG. 2A, a first image 100 depicts a site 102 and the surrounding area. A time stamp indicating a first time may be associated with the image 100. The site 102 within the image 100 includes a relatively flat/graded area 104, which is surrounded by hilly terrain. Image processing unit 26 may detect the graded area 104, and the bounds of area 104, using any suitable processing techniques, such as analyzing the uniformity of texture, shading, and/or color throughout the area 104 (e.g., uniformity that would likely be lacking in the presence of hills, ravines, woods, etc.), and/or using edge detection techniques, for example. In some embodiments and/or scenarios, image processing unit 26 may detect the graded area 104 by way of detecting changes to one or more characteristics (e.g., texture, shading, color, etc.) of the area 104 over time. For example, an earlier-captured image (not shown in FIGS. 2A-2C) of images 32 may depict at least the area 104 as it existed before grading of the land began.

In FIG. 2B, a second image 150 depicts the site 102 and surrounding area at a second, later time, which may also be indicated via a time stamp. As seen in FIG. 2B, additional roads 152 are now present within the graded area 104. Image processing unit 26 may detect the presence of the roads 152, and/or one or more characteristics of the roads 152, using any suitable processing techniques. For example, image processing unit 26 may detect the circular shapes of cul-de-sacs 154 in the roads 152. As another example, image processing unit 26 (and/or identification unit 28) may determine an average distance between intersections (e.g., in absolute terms, or relative to the width of roads 152, etc.). In still other examples, image processing unit 26 (and/or identification unit 28) may determine an overall density of roads 152 within a particular area (e.g., within graded area 104), or a total number of intersections within the area, etc.

In FIG. 2C, a third image 200 depicts the site 102 at a third, still later time, which again may be indicated via a time stamp. As seen in FIG. 2C, a number of home foundations 202 are now also present within the graded area 104. Image processing unit 26 may detect the presence of the foundations 202, and/or one or more characteristics of the foundations 202, using any suitable processing techniques. For example, image processing unit 26 may use edge and/or shape detection techniques to detect the presence of the foundations 202, and possibly the dimensions (or relative dimensions) of the foundations 202. Moreover, image processing unit 26 (and/or identification unit 28) may calculate metrics based on these characteristics, such as average dimensions of the foundations 202.

The housing development construction activity seen in FIGS. 2A-2C may be detected in various different ways, according to different embodiments. In some embodiments, a determination may be made based only upon characteristics that were detected within a single image corresponding to a single time. For instance, if identification unit 28 executes an algorithm specifying that housing development construction activity is indicated only if (1) a flat/graded area of at least some threshold size is detected, and (2) at least six intersections are detected within the graded area, then identification unit 28 may indicate a new housing development for image 150, but not for the earlier image 100. As another example, if identification unit 28 executes an algorithm specifying that housing development construction activity is indicated only if (1) a flat/graded area of at least some threshold size is detected, (2) at least six intersections are detected within the graded area, and (3) at least five house foundations are detected within the graded area, then identification unit 28 may indicate a new housing development for image 200, but not for the earlier images 100 and 150.

In other embodiments, however, a determination may be made based upon characteristics detected within multiple images of a site/area captured over time (e.g., days, weeks, months, etc.). For instance, identification unit 28 may only indicate a new housing development if a particular sequence of stages, each associated with its own criteria, is detected. As a more specific example, identification unit 28 may execute an algorithm specifying that housing development construction activity is indicated only if (1) a flat/graded area of at least some threshold size is detected in a first image, (2) roads (or additional roads) are detected within the graded area in a second, later image, and (3) house foundations are detected within the graded area in a third, still later image.

While relatively simple algorithms have been provided for illustration purposes, it is understood that much more complex algorithms may be used. For example, the algorithm may require determining various distances, dimensions, etc. (e.g., road lengths, distances between intersections, relative dimensions of house foundations, etc.), calculating metrics or statistics based on that information (e.g., minimums, maximums, means and standard deviations, etc.), and then using those metrics to determine whether a new housing development is in progress.

Moreover, in some embodiments, a “confidence score” may be calculated at each of multiple times/stages. For instance, each detected intersection at site 102 may add a value of “50,” each new road at site 102 may add a value of 100, each house foundation at site 102 may add a value of 20, and so on. Identification unit 28 may indicate a new housing development only when the score reaches a predetermined threshold or, alternatively, may provide an indication of confidence/likelihood at each of multiple times/stages, for example.

### IV. Example Methods of Detecting Real Estate Development Construction Activity

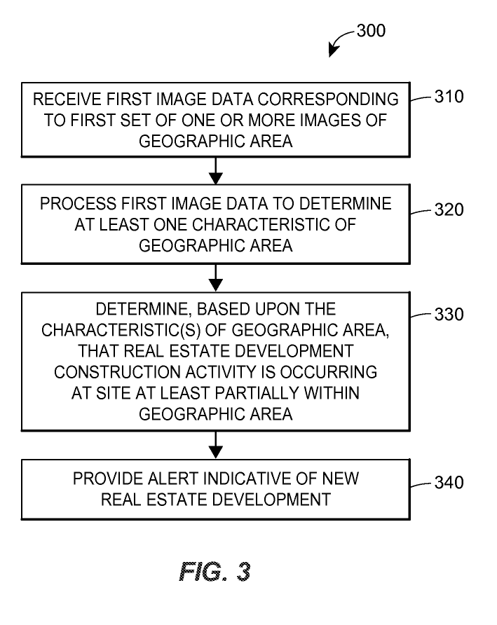

FIG. 3 depicts a flow diagram of an example method 300 for detecting new real estate development construction activity, according to an embodiment. In one embodiment, the method 300 may be implemented in (e.g., performed by one or more processors of) a server, such as the server 12 of FIG. 1, for example. The method 300 corresponds to a scenario in which construction activity for a new real estate development is pictured within the processed image(s).

In the method 300, first image data, corresponding to a first set of one or more images of a geographic area, may be received (block 310). The first set of images may include satellite images, such as the images 32 of FIG. 1, and/or any other images taken from a generally remote, non-terrestrial location. The first image data may be received via a communication interface, such as communication interface 24, and according to any of the methods described above in connection with FIG. 1, for example.

In some embodiments and/or scenarios, the first set of images includes a plurality of images that all depict the same geographic area, but were captured at different times. For example, each image may correspond to a different day, week or month. Thus, the images may depict a progression/series of changes to the geographic area over time. Alternatively, the first set may include only one image, or a plurality of images of the geographic area that were all taken at nearly the same time (e.g., as a single satellite passed over the area).

The first image data may be processed to determine at least one characteristic of the geographic area depicted in the image(s) (block 320). The processing may be performed by an image processing unit, such as image processing unit 26 of FIG. 1, and may use any suitable image processing techniques, such as any of those discussed above in connection with image processing unit 26.

The determined characteristic(s) may include any feature(s) indicative of the presence of, or the lack of, real estate development construction activity at a site within the geographic area. For example, the characteristic(s) may include characteristics/features of roads within the geographic area, such as a number, density or frequency of roads or road intersections within the geographic area, and/or the presence of cul-de-sacs within the roads. As another example, the characteristic(s) may include a grading of land within the geographic area (e.g., “uneven,” “flat,” or possibly intermediate levels of flatness). As yet another example, the characteristic(s) may include foundation footprints (e.g., for concrete foundations of homes or other buildings) within the geographic area. As still another example, the characteristic(s) may include above- or below-ground utility lines (e.g., electrical lines, water lines before they have been buried, etc.).

In embodiments/scenarios where the first set of images includes images taken at different times (e.g., at least days apart), the processing at block 320 may also determine one or more changes to the geographic area over time. For example, it may be determined that a flat/graded area exists where there was once uneven ground, that more roads are now within the geographic area, and so on. Thus, the characteristics determined at block 320 may include changes to other characteristics of the geographic area (e.g., “more” roads or intersections, or a change from uneven to flat/graded land, etc.).

In the particular scenario of the method 300, it is determined, based upon the characteristic(s) determined at block 320, that real estate development construction activity is indeed occurring at a site at least partially within the geographic area (block 330). Any suitable algorithm may be used, such as any of the algorithms discussed above in connection with identification unit 28 of FIG. 1, for example. In embodiments where the determination at block 330 is made at least in part based upon metrics pertaining to characteristics determined at block 320 (e.g., average distance between intersections, etc.), those metrics may be calculated at block 320 and/or at block 330.

The determination at block 330 may also be made based upon one or more factors other than the characteristic(s) determined at block 320. For example, the determination may also be based upon the proximity of the site, and/or of the depicted geographic area, to a large population center (e.g., a city with at least some threshold population, etc.). The algorithm underlying the determination at block 330 may require that the photographed area be within 200 miles of a city or town with a population of at least 50,000, for example, or may increase a “confidence score” in a manner that in inversely proportional to distance to a major city and directly proportional to the population of that city.

In response to the determination at block 330, an alert indicative of a new real estate development is provided (block 340). The alert may be provided to any employee(s), contractor(s) and/or other individual(s), to any department(s) of a company/entity, and/or to one or more computer systems (e.g., employees or systems of an insurance provider), and may indicate the location of the new real estate development. In some embodiments, the alert may also indicate a degree of confidence or likelihood that the new real estate development is being built, and/or a type or category of the development (e.g., residential/housing, commercial, industrial, etc.). The alert may be the same as, and/or provided in the same manner as, any of the types of alerts/data/messages described above in connection with alert unit 30 of FIG. 1, for example.

The alert may cause a second set of one or more images of at least a portion of the geographic area to be captured. For example, the second set of images may be captured in order to obtain better-resolution images that facilitate risk underwriting with respect to one or more insurance policies. The second set of images may be UAV images such as images 34 of FIG. 1, for example. In this manner, an underwriting department may have quick and ready access to detailed visual information about homes or other properties in the new real estate development when it comes time to underwrite policies for those properties.

In some embodiments, the method 300 also includes one or more blocks not shown in FIG. 3. For example, the method 300 may also include, after block 340, receiving (e.g., via a communication interface such as communication interface 24) second image data corresponding to the second set of images described above, and using the second image data to facilitate risk underwriting with respect to one or more insurance policies.

As another example, the method 300 may also include determining, based upon the characteristic(s) determined at block 320, an estimated completion date or date range for the new real estate development. The estimated date or date range may then be included in the alert provided at block 340, for example.

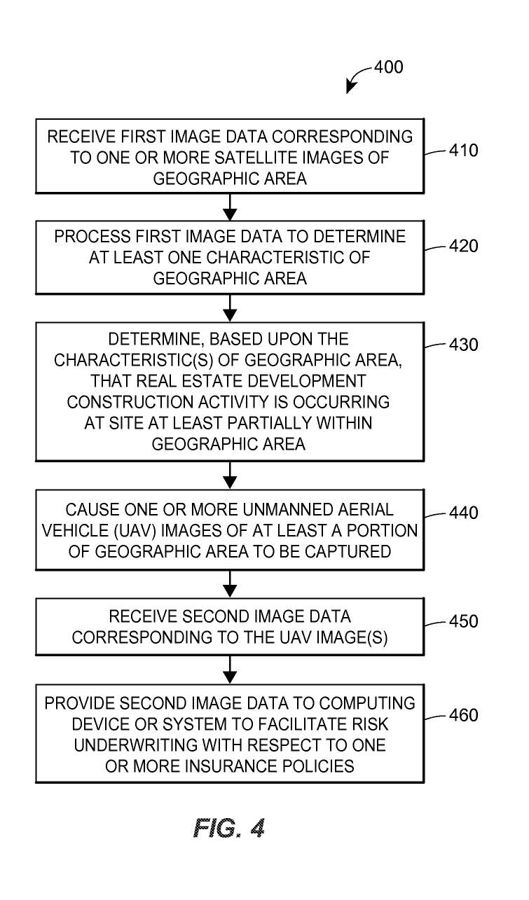

FIG. 4 depicts a flow diagram of an exemplary method 400 for detecting new real estate development construction activity for insurance purposes, according to an embodiment. In one embodiment, the method 400 may be implemented in (e.g., performed by one or more processors of) a server, such as the server 12 of FIG. 1, for example. Similar to the method 300, the method 400 corresponds to a scenario in which construction activity for a new real estate development is pictured within the image(s) being processed.

Blocks 410, 420 and 430 may be similar to blocks 310, 320 and 330 of the method 300, respectively. While the first set of images in the method 300 may or may not include satellite images, however, the images received at block 410 do include satellite images (e.g., images captured by satellites 14 of FIG. 1).

In response to determining that real estate development construction activity is occurring at the site at block 430, one or more UAV images of at least a portion of the geographic area are caused to be captured (block 440), e.g., as discussed above in connection with the alert unit 30 of FIG. 1. For instance, an alert/message may be sent to an employee or contractor of the insurance provider, who may then request or otherwise initiate a UAV survey (or periodic UAV surveys) of the geographic area.

Thereafter, second image data corresponding to the one or more UAV images may be received (block 450). The second image data may be received via a communication interface such as communication interface 24, and according to any of the methods described above in connection with FIG. 1, for example.

The second image data may be provided to a computing device or system to facilitate risk underwriting with respect to one or more insurance policies (block 460). For example, the second image data may be stored in a database that the underwriting department can access to analyze risk associated with homes/properties in the new real estate development. In different embodiments, the images may be stored for analysis at a later time (e.g., on an “as needed” basis), or the images may be automatically processed at an earlier time in order to determine risk-related characteristics of homes or other properties in the development, with those characteristics being stored for potential later use.

### VI. Additional Considerations

The following additional considerations apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the embodiments herein. This is done merely for convenience and to give a general sense of the invention. This description should be read to include one or at least one and the singular also includes the plural unless it is obvious that it is meant otherwise.

The patent claims at the end of this patent application are not intended to be construed under 35 U.S.C. § 112(f) unless traditional means-plus-function language is expressly recited, such as “means for” or “step for” language being explicitly recited in the claim(s).

1. A computer-implemented method of detecting real estate development construction activity, the method comprising:
receiving, by one or more processors, first image data corresponding to a first image of a geographic area;
processing, by one or more processors, the first image data to determine a first set of one or more characteristics of the geographic area, wherein determining the first set of one or more characteristics includes detecting an area of graded land;
determining, by one or more processors, that the first set of one or more characteristics satisfies a first set of one or more criteria indicative of a first stage of construction activity, wherein determining that the first set of one or more characteristics satisfies the first set of one or more criteria includes determining that the area of graded land exceeds a threshold;
receiving, by one or more processors, second image data corresponding to a second image of the geographic area;
processing, by one or more processors, the second image data to determine a second set of one or more characteristics of the geographic area, wherein determining the second set of one or more characteristics includes detecting a number of foundation footprints within the area of graded land;
determining, by one or more processors, that the second set of one or more characteristics satisfies a second set of one or more criteria indicative of a second stage of construction activity, wherein determining that the second set of one or more characteristics satisfies the second set of one or more criteria includes determining that at least a threshold number of foundation footprints are within the area of graded land;
determining, by one or more processors and based at least upon (i) the determination that the first set of one or more characteristics satisfies the first set of one or more criteria and (ii) the determination that the second set of one or more characteristics satisfies the second set of one or more criteria, that real estate development construction activity is currently occurring at a site at least partially within the geographic area; and
in response to determining that real estate development construction activity is currently occurring at the site, sending an automated electronic message to one or more individuals, the automated electronic message including a map image on which a graphical icon indicates a location of the real estate development construction activity.

2. The computer-implemented method of claim 1, wherein receiving first image data corresponding to a first image of a geographic area includes receiving first image data corresponding to a first satellite image.

3.-5. (canceled)

6. The computer-implemented method of claim 1, wherein processing the second image data to determine a second set of one or more characteristics of the geographic area includes determining one or more characteristics of roads within the geographic area.

7. (canceled)

8. The computer-implemented method of claim 1, wherein (i) processing the first image data to determine a first set of one or more characteristics of the geographic area, or (ii) processing the second image to determine a second set of one or more characteristics, includes detecting earth-moving construction equipment within the geographic area.

9-10. (canceled)

11. The computer-implemented method of claim 1, wherein:
determining that real estate development construction activity is currently occurring at the site is further based upon a proximity of the site, or of the geographic area, to a population center.

12. The computer-implemented method of claim 1, further comprising:
determining, by one or more processors and based upon one or both of (i) the first set of one or more characteristics of the geographic area and (ii) the second set of one or more characteristics of the geographic area, an estimated completion date or date range for the new real estate development.

13. A system for detecting real estate development construction activity, the system comprising:
a communication interface;
one or more processors; and
a program memory storing instructions that, when executed by the one or more processors, cause the one or more processors to
process first image data, received via the communication interface and corresponding to a first image of a geographic area, to determine a first set of one or more characteristics of the geographic area, wherein determining the first set of one or more characteristics includes detecting an area of graded land,
determine that the first set of one or more characteristics satisfies a first set of one or more criteria indicative of a first stage of construction activity, wherein determining that the first set of one or more characteristics satisfies the first set of one or more criteria includes determining that the area of graded land exceeds a threshold,
process second image data, received via the communication interface and corresponding to a second image of the geographic area, to determine a second set of one or more characteristics of the geographic area, wherein determining the second set of one or more characteristics includes detecting a number of foundation footprints within the area of graded land,
determine that the second set of one or more characteristics satisfies a second set of one or more criteria indicative of a second stage of construction activity, wherein determining that the second set of one or more characteristics satisfies the second set of one or more criteria includes determining that at least a threshold number of foundation footprints are within the area of graded land,
determine, based at least upon (i) the determination that the first set of one or more characteristics satisfies the first set of one or more criteria and (ii) the determination that the second set of one or more characteristics satisfies the second set of one or more criteria, that real estate development construction activity is currently occurring at a site at least partially within the geographic area, and
in response to determining that real estate development construction activity is currently occurring at the site, send an automated electronic message to one or more individuals, the automated electronic message including a map image on which a graphical icon indicates a location of the real estate development construction activity.

14. (canceled)

15. The system of claim 13, wherein one or both of (i) the first set of one or more characteristics of the geographic area, and (ii) the second set of one or more characteristics of the geographic area, includes one or more of (i) one or more characteristics of roads within the geographic area, or (ii) a presence of earth-moving construction equipment within the geographic area.

16. (canceled)

17. The system of claim 13, wherein the instructions further cause the one or more processors to:
determine, based upon one or both of (i) the first set of one or more characteristics of the geographic area and (ii) the second set of one or more characteristics of the geographic area, an estimated completion date or date range for the new real estate development.

18-20. (canceled)
